(19) United States
(12) Patent Application Publication
(10) Pub. No.: US 2016/0056029 A1
(43) Pub. Date: Feb. 25, 2016

(54) Apparatus and Methods for an Atmospheric Sampling Inlet for a Portable Mass Spectrometer

(71) Applicant: Yongqiang Qiu, San Rafael, CA (US)

(72) Inventor: Yongqiang Qiu, San Rafael, CA (US)

(73) Assignee: BaySpec, Inc., San Jose, CA (US)

(21) Appl. No.: 14/466,918

(22) Filed: Aug. 22, 2014

(51) Int. Cl. H01J 49/04; H01J 49/24

(52) U.S. Cl. CPC H01J 49/0422; H01J 49/0404; H01J 49/24

(57) ABSTRACT

Atmospheric sampling system designed to minimize cross-contamination between successive samples acquired by a portable, or handheld, mass spectrometer. Techniques to reduce the overall sample load on portable mass spectrometers having limited pumping capacity, such as capture pumps. Techniques and methods employing simple manual devices and micro vacuum pumps for purging the inlet system of a mass spectrometer. Reduction of cross-contamination between successive samples, permitting a portable mass spectrometer to correctly associate sample positives with specific sample sites or individuals.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates generally to the field of mass spectrometry and specifically to direct atmospheric sampling of chemical samples, with particular emphasis on devices and methods for reducing cross-contamination between samples and reducing the pumping requirements of vacuum systems that utilize capture pumps, such as ion pumps, cryopumps, or getter pumps.

Mass spectrometry involves the measurement of very small quantities of chemical compounds that must ordinarily be transferred from atmospheric pressure into a vacuum manifold which is typically maintained at a pressure ranging from 10⁻² Torr to 10⁻⁸ Torr.

Most mass spectrometers installed in laboratories today are used to analyze samples that are brought to the instrument and prepared for analysis through use of either a gas chromatograph or a liquid chromatograph inlet. However, an increasing number of portable mass spectrometers are being used to perform direct analysis of compounds at the location of the sample itself. These sampling systems often involve the direct injection of an atmospheric sample containing potential compounds of interest.

One of the earliest techniques employed for mass spectrometer sampling of an atmospheric sample is referred to as DART (Direct Analysis in Real Time). One implementation of this is described in a patent by Nilles et al. (U.S. Pat. No. 8,592,758) “Vapor Sampling Adapter for Direct Analysis in Real Time Mass Spectrometry”. The approach described by Nilles involves use of a heated vapor transfer line attached to a mass spectrometer. The mass spectrometer itself is relatively heavy, but still portable, permitting it to be transported to the vicinity of the compounds to be analyzed. The heated vapor transfer line described by Nilles may be extended to a length of 20 feet, allowing the mass spectrometer to be left in a single location, while samples within a 20 foot radius of the mass spectrometer may be analyzed.

The approach adopted by DART and other direct sampling techniques has typically employed a continuous stream of atmospheric effluent that is directed into the mass spectrometer for analysis. However, a different approach was taken by Ouyang (U.S. Pat. No. 8,304,7180) “Discontinuous Atmospheric Pressure Interface”. The sampling system described by Ouyang has been referred to as DAPI, and performs ionization of the sample compound external to the mass spectrometer though use of a plasma source, after which the ionized sample is injected into the mass spectrometer in a discontinuous manner through use of an electrically operated pulse valve.

With the DAPI approach of Ouyang, the sample is not acquired in a continuous stream, but is broken into a discontinuous collection of sample acquisitions. The DAPI approach may be used to reduce the overall load on the mass spectrometer pumping system by limiting sample injection time, and may also be used to associate each acquired sample spectrum with an individual sample, or sampling location. This approach has a definite advantage when there are many different samples that need to be analyzed and it is important to associate a mass spectrum with each particular sample, as might be utilized for the sampling of individual items of luggage, or of individual people moving through a security checkpoint.

When a portable mass spectrometer is employed in a system used to sample individual items, or individual people, it becomes important to eliminate cross-contamination between the analyzed samples. This requirement has an analogy when a mass spectrometer is used in conjunction with a gas chromatograph for analyzing a collection of samples, such as environmental or toxicology samples. For these applications, it is considered good laboratory practice to inject a blank sample between each real-world sample to verify that there is no carry-over from one sample to the next.

Currently, portable mass spectrometers performing field sampling have not completely addressed this potential problem. The challenges of building a truly portable mass spectrometer have placed limits on the size and complexity of the instrument design, and techniques for limiting cross-contamination between samples has received little attention. However, as portable mass spectrometers are finding increased application in the sampling of individual items and people, the need to reduce the potential for cross-contamination between samples will increase.

### BRIEF SUMMARY OF THE INVENTION

The invention involves several techniques that permit the sampling inlet system of a portable mass spectrometer to be operated in a simple and efficient manner, while minimizing cross-contamination between each sample, and reducing the load on the mass spectrometer vacuum system, especially for those instruments that utilize capture pumps.

One embodiment of the invention permits the inlet system of a portable mass spectrometer to be quickly and simply purged by connecting the sample inlet line, used for the transfer of the atmospheric sample to the mass spectrometer, to the vacuum pump of the instrument through use of a manual, or electrically operated, pulse valve. In this manner, the pulse valve, which may be controlled either manually or electrically, may be briefly opened, thereby purging the previous sample volume from the sample inlet lines.

This approach has the advantage that it can be accomplished very quickly. If an electrically controlled pulse valve is employed, it's possible to open the valve for only a short period of time (typically less than 100 msec), which is enough time to remove the previous sample volume from the instrument inlet line and pump the sample volume out through the instrument's vacuum system.

In another embodiment, the previous sample volume may be purged from the inlet system without using the instrument's vacuum system. In this approach, a simple rubber bulb is used to evacuate the inlet line. After a sample has been analyzed, the rubber bulb is compressed and placed over the sample inlet port. The rubber bulb is then released, allowing the sample to be drawn out of the inlet line and into the rubber bulb volume. This process may be repeated several times to completely evacuate the sample inlet line and pulse valve.

Another embodiment of this technique utilizes an additional port placed in the sample inlet line, and located as close to the pulse valve as possible. In this configuration, the rubber bulb may be placed over the added port, and alternately compressed and released, effectively purging the sample inlet line. Additionally, with this configuration, the rubber bulb may be placed over the sample inlet port. Then, with the additional port left open, the alternate compression and release of the rubber bulb will purge the sample inlet line. During normal sample operation, the added port must be closed off through use of a valve, or a tight cap.

The use of a simple rubber bulb to purge the sample inlet line has the advantage of being both easy and simple to implement, but also has the advantage that purging the sample inlet line does not place any additional gas load on the vacuum system of the portable mass spectrometer. The ability to purge the sample inlet system without increasing the gas load on the mass spectrometer is a significant advantage, as the vacuum system of a portable mass spectrometer is typically quite limited, owing to the size and weight constraints of a portable instrument. This situation is especially crucial when a mass spectrometer employs a capture pump, which has an inherently limited pumping volume.

Another embodiment of the invention makes use of a micro vacuum pump, which is capable of generating a small vacuum sufficient to remove the majority of the previous sample from the inlet system. With this approach, the sample inlet line may be effectively purged without placing an additional load on the vacuum pump of the mass spectrometer, or without requiring the manual operation of a rubber bulb.

### BRIEF DESCRIPTION OF THE DRAWINGS

FIG. 1 shows a simple direct atmospheric sampling system employing a single pulse valve.

FIG. 2 shows a modified direct atmospheric sampling system employing two pulse valves and capable of reducing cross-contamination between samples.

FIG. 3 shows a modified direct atmospheric sampling system designed to reduce cross-contamination incorporating a simple, manually operated rubber bulb.

FIG. 4 shows a close-up drawing of the inlet port and a simplified method of pinching off the inlet port. When the inlet port is closed, the sample inlet line and pulse valve may be purged by temporarily connecting the inlet line to a vacuum pump. When the inlet port is open, it is ready to acquire a sample.

FIG. 5 shows a drawing of an inlet system employing a portable mass spectrometer with an internal capture pump, no fore-vacuum pump, and a micro vacuum pump used for removing contamination products from the inlet system.

### DETAILED DESCRIPTION OF THE INVENTION

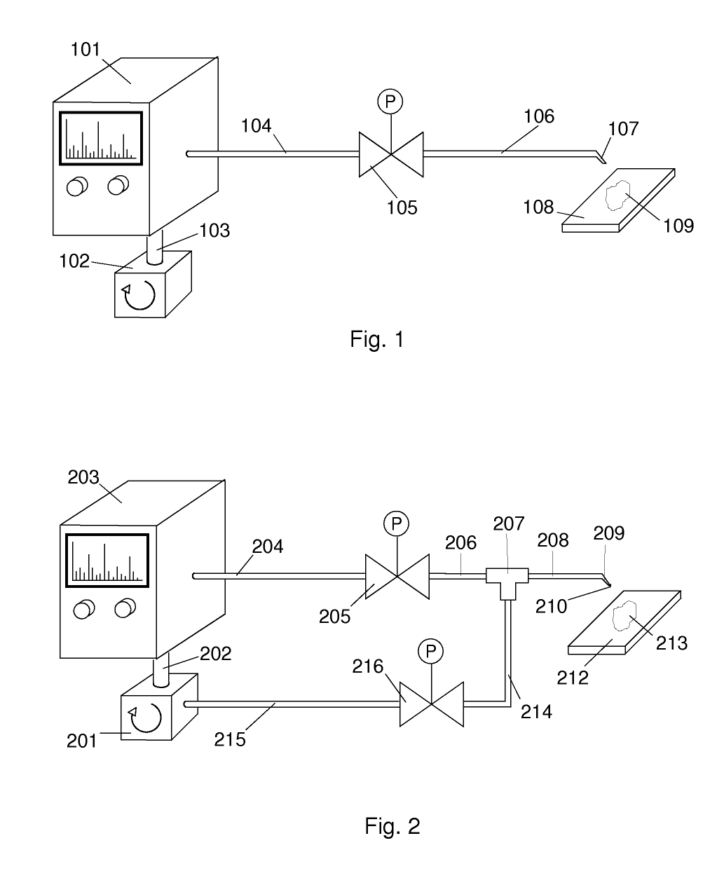

A very simple direct atmospheric sampling inlet system is illustrated in FIG. 1. The mass spectrometer detector is shown at 101, connected to a vacuum pump at 102 through interface manifold 103. The actual sample to be analyzed is shown at 109 residing on surface 108. The sample, and a volume of atmospheric air, is injected through the inlet port at 107 and passed through the capillary shown at 106. The injection time is controlled by electrically opening the normally closed pulse valve shown at 105. The pulse valve 105 is a normally closed pulse valve that briefly opens when a voltage pulse is applied to the valve. During this injection time, the sample passes though the pulse valve 105, and through the capillary section shown at 104, and into the mass spectrometer manifold 101 where it will be analyzed.

The inlet port 107 may have a variety of configurations. It's main function is to allow a sample to be introduced into a capillary line that ultimately passes into the mass spectrometer itself. Because an atmospheric sample may contain particulate matter, it is preferable for the inlet port to have an internal diameter slightly smaller than the capillary line. In this manner, the inlet port may be changed, or cleaned, should the inlet port become blocked by any sort of injected particulate matter.

FIG. 1 illustrates the importance of the pulse valve 105, since during the injection time the mass spectrometer is briefly connected to atmosphere through capillary sections 104 and 106. The injection time must be controlled electronically and kept very short, typically lasting from 5 milliseconds to 20 milliseconds. Likewise, the injected sample volume must be limited by choosing a capillary inlet (104 and 106) that has a small inner diameter, typically on the order of 0.25 millimeters.

The injection system shown in FIG. 1 is very simple, with a minimum of components, yet it presents several problems with cross-contamination between samples. To start with, after a sample volume has been injected into the mass spectrometer through the pulse valve 105, some sample volume will still remain inside capillary section 106. The next time a sample is taken, some sample volume from the previous sample will be injected into the mass spectrometer, along with the sample from the current injection, contributing to the cross-contamination of the analyzed sample.

Another source of cross-contamination between successive samples is with the pulse valve itself. The interior of the pulse valve, although it is a fairly simple structure, still has an interior volume of 10 or more micro-liters that can hold sample from the previous injection.

An effective method of dealing with the types of cross-contamination that could be generated from the injection system of FIG. 1 is addressed by the sampling system shown in FIG. 2. FIG. 2 shows the mass spectrometer detector 203, with its vacuum pump 201, connected to the mass spectrometer manifold through vacuum interface 202. The sample is shown at 213 residing on surface 212. The inlet system of FIG. 2 has several new components. These new components are another pulse valve 216, a Tee connector 207, and a pinch mechanism 210 used to control sample flow into the capillary 208.

When a sample is taken using the inlet system of FIG. 2, it passes through the injection port 209 and into capillary section 208, through the Tee connector 207, and into the mass spectrometer through capillary sections 206 and 204 and pulse valve 205.

After injection and analysis of the sample, there will still be some residual component of the sample remaining in capillary sections 206 and 208, and also in the internal volume of pulse valve 205. At this point a quick cleaning operation can be performed by using pulse valve 216 and the pinch mechanism shown at 210. To implement this cleaning procedure, the injection port 209 is closed though activation of the pinch mechanism 210 (illustrated in more detail in FIG. 4). At this time, pulse valve 216 is activated, which connects the capillary sections 206, 208, 214 and 215 directly to the mass spectrometer vacuum pump 201. This purging operation will effectively remove the residual sample from the capillary inlet lines, and the internal volume of the pulse valve 205. This operation will occur very quickly, requiring the pulse valve 216 to be opened for typically only 10 or 20 milliseconds. After this purging time, pulse valve 216 will be closed and pinch mechanism 210 will be released, allowing the next sample to be taken with a clean inlet system.

When the purging method illustrated in FIG. 2 is implemented, in addition to a reduction in cross-contamination, there is also an improvement in pumping capacity when used with a portable mass spectrometer that employs a capture pump. If the mass spectrometer 203 contains a capture pump, such as an ion pump, a cryopump, or a getter pump, then the pumping capacity of the mass spectrometer is limited by the capacity of the capture pump. In this configuration, the mass spectrometer manifold would contain a capture pump, and an additional small roughing pump attached externally to the analyzer manifold, such as would be shown by the pump at 201 and the interface at 202.

When a capture pump is used in a configuration as shown in FIG. 1, each sample will suffer from cross-contamination from the previous sample. The typical method of removing cross-contamination in such circumstances is to acquire one or more additional samples of an uncontaminated volume of atmospheric air. These purging samples are then discarded. This will allow the inlet system to be purged, but it will inject additional sample volume into the mass spectrometer manifold. If the manifold contains a capture pump, then this additional sample load from the purging samples must be pumped away by the capture pump, which decreases the time during which the portable mass spectrometer can be operated.

However, using the configuration shown in FIG. 2, the inlet capillary lines, and the internal volume of the pulse valve, is purged by venting the residual sample directly into the roughing pump of the mass spectrometer, effectively bypassing the capture pump of the mass spectrometer analyzer. In this manner, successive samples can be taken with the portable mass spectrometer with the residual effluent of each sample purged before the following sample is taken, and done without adding any additional load to the capture pump.

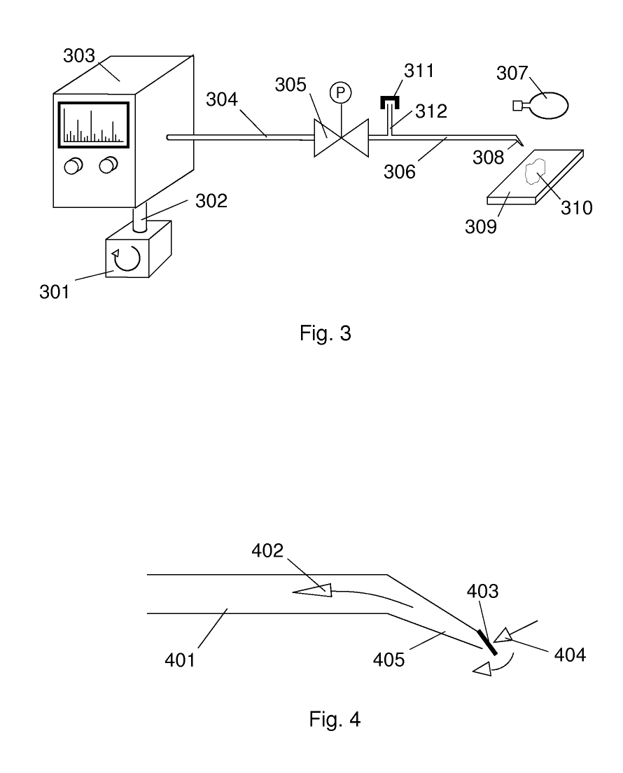

The design of a portable mass spectrometer can be very challenging since the instrument must be kept as small and as light as possible, yet still maintain an ability to produce reliable data. Additionally, if the portable mass spectrometer is used to analyze samples from individual items, or individual people, the reduction of cross-contamination effects is very important. FIG. 3 illustrates a simple method of reducing cross-contamination between samples with only a minimum of additional hardware.

The inlet system of FIG. 3 comprises the mass spectrometer 303 connected to a vacuum pump 301 through vacuum interface 302. The sample is shown at 310 on surface 309. The sample is injected through the inlet port 308 and into the capillary segment 306, through the pulse valve 305, the capillary section 304, and into the mass spectrometer 303 for analysis. After the sample has been acquired, there will still be some residual sample remaining in the capillary section 306 in addition to a residual component remaining in the internal volume of the pulse valve 305.

After a sample has been injected into the mass spectrometer and analyzed using the system illustrated in FIG. 3, the residual sample component left in the capillary sections and pulse valve can be simply removed by compressing the rubber bulb 307, placing the compressed rubber bulb 307 over the inlet port 308, and then releasing the rubber bulb 307. This will serve to draw out the sample from the capillary inlet line and the pulse valve with a minimum of additional hardware. For a portable mass spectrometer used in a field environment, this approach allows for a reduction in cross-contamination between samples and a reduction in the sample load placed upon a capture type pump, if a capture pump is being used, with only the addition of a simple rubber bulb. The rubber bulb itself may be selected from virtually any sort of syringe type rubber bulb, having a typical inner volume of 100 cc.

In another embodiment, a Tee connection and an additional port 312 can be placed near the inlet of the pulse valve 305. This additional port is normally left closed during sample acquisition by use of a simple cap 311 or valve. This permits the inlet line to be quickly purged after sampling by removing the cap 311 and connecting the rubber bulb 307 to this additional port 312. By compressing and releasing the rubber bulb, atmospheric air will purge the sample inlet line 306. The pulse valve 305 can be purged by compressing the rubber bulb, closing the inlet port 308, and then releasing the rubber bulb and drawing sample volume out of the pulse valve.

An additional embodiment permits the sample inlet to be purged by placing the rubber bulb 307 over the inlet port 308, opening the cap 311 on the additional port 312, and compressing and releasing the rubber bulb. This will also effectively purge the sample inlet line 306. The rubber bulb can then be compressed, the cap 311 placed back over the additional port 312, and then when the rubber bulb is released, the pulse valve 305 will be purged.

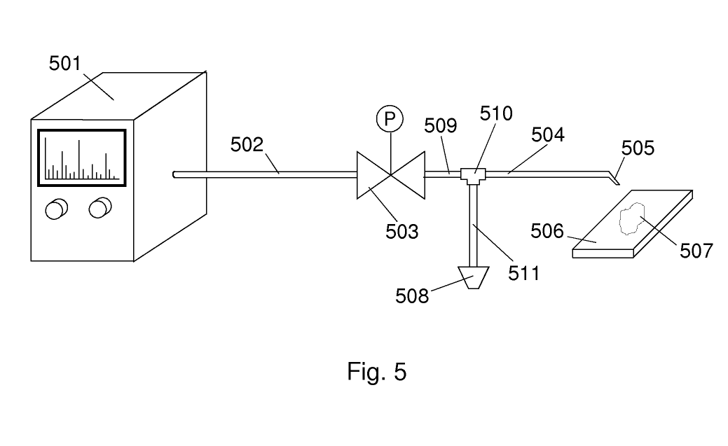

The use of the additional port 312 provides an extra level of purging of the sample inlet line. It is used primarily to speed the process of purging the sample inlet line. In practice it is not required, as the sample inlet system can be operated and effectively purged through the approaches described in FIG. 1, FIG. 2, and FIG. 5.

If the mass spectrometer sampling system is used according to the method illustrated in FIG. 2, it is necessary to provide a method of pinching off the inlet port 210 to permit the residual sample remaining in the capillary lines 206 and 208, and the pulse valve 205, to be evacuated. The pinching of the inlet port can be achieved in a variety of different methods. One approach is shown in FIG. 4. The inlet port is shown at 405, which feeds into the capillary inlet line 401. The sample effluent flows through the inlet port and into the capillary inlet as shown at 402. Attached to the inlet port is a small metal or plastic flap shown at 403. Manual pressure from the operator's finger is placed perpendicularly onto flap 403, as shown at 404. This will effectively seal off the inlet port, allowing the activation of the second pulse valve 216, which purges the inlet capillary lines 206 and 208. After this purging time the pulse valve 216 is deactivated and the flap 403 is opened, permitting the next sample to be injected.

The manual activation of the flap 403 by the operator has the distinct advantage of reducing the overall complexity and size of the portable mass spectrometer. However, it would also be possible to implement an embodiment of the sampling system in which an electrically operated solenoid valve is used to control the injection of sample into the inlet port.

Although there are a variety of simple flaps that may be employed to temporarily close the inlet port, it is also possible for the operator to simply place his finger directly over the inlet port 405. The capillary inlet line for the mass spectrometer sampling system will have an internal diameter of less than 1 mm, so it is possible for the operator to place virtually any object over the inlet to effectuate a workable seal, including a simple bare finger, or a finger covered with a piece of plastic tubing, or tape, in order to prevent any possible contamination produced by the operator's skin itself.

In addition to the embodiments described, there are many additional configurations of a mass spectrometer sampling system that may be employed. Although a mechanical vacuum pump is shown in FIG. 1, FIG. 2, and FIG. 3 as a separate module connected to the mass spectrometer manifold, it is also possible for a small turbomolecular pump to be installed in the mass spectrometer manifold itself, with a small roughing pump attached externally to the mass spectrometer manifold.

Another embodiment of the sampling system would comprise a capture pump, such as an ion pump, a cryopump, or a getter pump, installed within the mass spectrometer manifold itself, with a roughing pump attached externally to the mass spectrometer manifold.

In another embodiment, the sampling system could be used with a portable mass spectrometer that contains a capture pump, but does not have a roughing pump installed. Instead, the portable mass spectrometer is periodically connected to a pumping (docking) station, where a vacuum pump located within the pumping station is used to pump the portable mass spectrometer down to an appropriate operating pressure. When this operating pressure has been reached, the portable mass spectrometer is then removed from the pumping station and placed into operation using only its internal capture pump. In this configuration, the sampling system illustrated in FIG. 3 becomes very effective. The use of the pulse valve with the simple rubber bulb permits cross-contamination to be reduced, while also limiting the sample volume injected into the mass spectrometer manifold, effectively permitting a longer operating time before the portable mass spectrometer must be returned to the pumping station.

Another embodiment of the invention is illustrated in FIG. 5 and deals with the configuration in which the mass spectrometer is portable, or handheld, and operates with an internal capture pump and without a running fore-vacuum pump. This is the most crucial configuration with regards to pumping capacity, since every sample that is introduced into the mass spectrometer must be removed by the internal capture pump, which has an inherently limited pumping capacity.

The sampling system of FIG. 5 shows a portable mass spectrometer 501 operating with an internal capture pump and without any fore-vacuum pump. The sample to be analyzed is shown at 507, and is present on surface 506. The sample inlet port 505 connects to the mass spectrometer inlet through the capillary line 504, the Tee connector 510, the capillary line 509, the pulse valve 503, and the capillary line 502. In normal operation, the inlet port 505 is placed near the sample to be analyzed 507, and a volume of air and sample is collected by momentarily opening the pulse valve 503 for typically no more than ten or twenty milliseconds. After the pulse valve 503 is closed, the atmospheric sample will be present in the portable mass spectrometer 501 where it can be analyzed.

The inlet system shown in FIG. 5 may be purged through use of the micro vacuum pump shown at 508. When the micro vacuum pump 508 is activated, and the inlet port 505 is closed, it will evacuate the inlet capillary lines 504 and 509, and the Tee connector 510, by pumping through capillary line 511. The micro vacuum pump will also evacuate the internal volume of the pulse valve 503. After a first evacuation, the inlet port 505 may be opened again to atmosphere (with no sample), and then closed again to clean the inlet capillary 504, capillary 509, Tee connector 510 and the pulse valve internal volume 503. If the previous sample was very intense, it may require several purge operations to adequately clean the inlet system.

There are several types of micro vacuum pumps that can be used to implement the cleaning system illustrated in FIG. 5. One option is to use a Parker T2-05 Micro Vacuum Pump, which is very small and weighs less than 15 grams. The Parker T2-05 pump can create a vacuum as low as 10 inches of Mercury, corresponding to a 33% vacuum.

1. A pulsed atmospheric sampling system for a portable mass spectrometer comprising:
an inlet port for sample injection;
a controllable flap or barrier affixed to said inlet port;
a capillary line for transfer of said sample injection into said portable mass spectrometer;
a pulse valve for controlling the time period of said sample injection through said capillary line;
a tee connector located in said capillary line between said inlet port and said pulse valve, where the tee connector is connected to a vacuum source used for purging said sampling system between sample acquisitions.

2. The system of claim 1 in which said vacuum source is created from a fore-vacuum pump connected to said portable mass spectrometer.

3. The system of claim 1 in which said vacuum source is created from a turbomolecular pump located within said portable mass spectrometer.

4. The system of claim 1 in which said vacuum source is created from a capture pump located within said portable mass spectrometer.

5. The system of claim 1 in which said vacuum source is created from a micro vacuum pump weighing less than 1 ounce.

6. The system of claim 1 in which said controllable flap or barrier affixed to said inlet port is controlled manually by the operator's finger.

7. The system of claim 1 in which said controllable flap or barrier affixed to said inlet port is controlled by an electrically operated solenoid.

8. A pulsed atmospheric sampling system for a portable mass spectrometer comprising:
an inlet port for sample injection;
a capillary line for transfer of said sample injection into said portable mass spectrometer;
a pulse valve for controlling the time period of said sample injection through said capillary line;
a rubber bulb used to manually evacuate the previously injected sample from said capillary line and said pulse valve.

9. The sampling system of claim 8, in which said rubber bulb is used to purge the sample inlet line by compressing said rubber bulb, placing said rubber bulb over said inlet port, and releasing said rubber bulb, effectively purging said sample inlet line.

10. The sampling system of claim 8, in which an additional port with a corresponding cap or valve, is connected to said capillary line.

11. The sampling system of claim 10, in which said rubber bulb is placed over said additional port, and alternately compressed and released, effectively purging said sample inlet line.

12. The sampling system of claim 10, in which said additional port is opened to atmosphere, and said rubber bulb is placed over said inlet port and alternately compressed and released, effectively purging said sample inlet line.

13. A method for reducing sample cross-contamination from a pulsed atmospheric sampling system for a portable mass spectrometer by evacuating the inlet system components of the pulsed sampling system before acquiring and analyzing a sample.

14. The method of claim 13 in which the inlet system components are evacuated through use of a fore-vacuum pump connected to said portable mass spectrometer.

15. The method of claim 13 in which the inlet system components are evacuated through use of a turbomolecular pump located within said portable mass spectrometer.

16. The method of claim 13 in which the inlet system components are evacuated through use of a capture pump located within said portable mass spectrometer.

17. The method of claim 13 in which the inlet system components are evacuated through use of a manually operated rubber bulb connected to sample system inlet port.

18. The method of claim 13 in which the inlet system components are evacuated through use of a manually operated rubber bulb connected to a secondary port connected to the sample inlet line.

19. The method of claim 13 in which the inlet system components are evacuated through use of a micro vacuum pump weighing less than one ounce.
